(19) United States
(12) Patent Application Publication
(10) Pub. No.: US 2006/0056590 A1
(43) Pub. Date: Mar. 16, 2006

(54) Methods and apparatus of sample analysis

(75) Inventor: Andrei Nikulin, Glen Waverly (AU)

Correspondence Address: SEED INTELLECTUAL PROPERTY LAW GROUP PLLC, 701 FIFTH AVE, SUITE 6300, SEATTLE, WA, 98104-7092, US

(73) Assignee: Monash University, Clayton (AU)

(21) Appl. No.: 10/518,651

(22) PCT Filed: Jun. 16, 2003
(86) PCT No.: PCT/AU03/00748

§ 371 Date: Jul. 18, 2005

(30) Foreign Application Priority Data
Jun. 17, 2002 (AU) PS 2993

(51) Int. Cl. G01N 23/20

(52) U.S. Cl. 378/71

(57) ABSTRACT

An x-ray beam (4) from a rotating anode source (8) is passed through an object (1) via a monochromator (9) and slit member (10) in order to determine the object's internal structure. The emerging radiation that is within the acceptance angle of a crystal analyser (5) is diffracted onto a PIN diode detector (6), which records an intensity profile of the radiation detected as a function of angular position of the crystal analyser (5). The resulting profile is analysed to provide a complex refractive index profile for the object (1) across the width of the beam (4). The analysis method and apparatus utilises both absorption and refraction information, and can provide both qualitative and quantitative information on the object's structure, with the dimensions of the slit member (10) providing an analytical intensity profile.

The present invention relates to methods and apparatus for the analysis of a sample. It relates particularly to x-ray analysis, and has applications in both the medical and non-medical fields. It may be used in the analysis of organic and inorganic substances, and crystalline and amorphous materials.

X-ray analysis in the form of x-ray radiography is well-known in the medical field, and is a widely used technique for medical imaging.

In its simplest form, a radiographic device comprises an x-ray source and an x-ray sensitive film arranged opposite to one another on either side of a patient. X-rays from the source are directed at the patient's body” and those that pass through are recorded on the film. Since bone and soft tissue absorb different amounts of radiation, an image of lighter and darker areas is captured on the film, and can be used to identify internal structure of the patient.

A problem with this technique is that organic materials are generally weak absorbers of X-ray radiation, and so distinguishing between different types of soft tissue can be difficult. For example, it can be difficult to distinguish between healthy soft tissue and a tumour, especially in a tumours early stages.

X-ray techniques based on phase imaging have recently been promoted for overcoming this problem. Rather than use x-ray absorption, these methods attempt to provide better image contrast by utilising instead the phase shift of x-rays as they pass through regions of the sample of different refractive index. Phase imaging techniques can provide improvement over radiographic techniques, and can allow for better definition of soft tissue.

A problem with both radiographic and phase imaging techniques is that in order to use relatively short exposure times, they generally require the incident radiation to be of a relatively high intensity. Damage of the object under examination by the x-rays is therefore of concern. This is especially so in medical imaging, where strict protocols must be observed as to radiation dosages and the like.

A further point of note is that it can be difficult and expensive to obtain high resolution in both techniques. For example, even the use of the most expensive CCD cameras (CCD refers to charge couple device) on the market today still imposes undesirable limits on image resolution and dynamic range.

The present invention aims to provide an alternative x-ray analysis technique that, in its various aspects and embodiments, can provide a number of advantages both in the medical and non-medical fields.

Viewed from a first aspect, the present invention provides a method of analysis of an object, the method including the steps of:

generating non-planar penetrating radiation;

diffracting the radiation from a monochromator to provide a beam of monochromatic penetrating radiation;

irradiating a portion of the object with the beam;

diffracting radiation that passes through the object onto a detector from an analyser;

rotating the analyser through a plurality of angular positions; and

measuring the intensity of the radiation incident on the detector as a function of analyser position.

Viewed from a second aspect, the present invention provides apparatus for the analysis of an object, the apparatus including:

a source of non-planar penetrating radiation;

a monochromator for diffracting the non-planar penetrating radiation to provide a beam of monochromatic penetrating radiation;

a detector for detecting radiation that passes through the object;

an analyser for diffracting radiation that passes through the object onto the detector;

means for rotating the analyser between a plurality of angular positions; and

means for recording the intensity of the radiation incident on the detector as a function of analyser position.

Each intensity value detected through the present invention (i.e. for each angular position of the analyser) corresponds to the intensity of the x-ray photons that are diffracted by the analyser onto the detector from across the whole of the radiation beam that has penetrated the sample object. The resultant intensity profile includes information as to both the absorption and refraction of x-rays by the sample, and facilitates the determination of for example the shape and structure of the analysed portion in a single experiment.

As is preferred, the present invention allows for the determination of a complex scattering function of the analysed portion from the intensity measurements. This can provide the complex refractive index of the portion of the object under analysis as a function of cross-section transverse to the direction of propagation of the beam.

The invention contrasts with the prior art radiographic and phase contrast techniques that generally view the object under analysis either in a purely absorptive or in a purely phase manner.

The present invention is further distinct from the prior art in that it can be thought of as obtaining and analysing information in “reciprocal space” rather than in “real space”.

The present invention facilitates the analysis of an object at high resolutions in an inexpensive manner. For example, there is no need to use an expensive high resolution CCD detector, as the detector used in the present technique need not provide spatial resolution (spatial resolution is instead provided by the rotation of the analyser, and may be determined by the full aperture of angular rotation).

The present technique can provide higher resolution than the prior art, and may for example provide resolutions in the region of 0.05-0.5 nm.

The present invention is also able to efficiently utilise the x-ray photons emerging from the portion of the object analysed, since it effectively integrates the emerging x-rays across the whole width of the analysing beam, and the detector may start counting from a single photon of light. The present invention thus facilitates the use of x-ray radiation of lower intensity, and may provide better data statistics and so analysis quality than imaging techniques.

It should be noted that the present invention analyses non-Bragg diffracted x-rays exiting from the sample object, and thus is distinct from e.g. standard crystallography and the like.

Generally, an analysis of non-Bragg diffracted waves would be considered of no use, as it was not thought possible to obtain any meaningful information from such an analysis. Indeed, the idea of obtaining diffraction effects at all for non-periodic structures, such as amorphous materials was not entertained.

The inventor of the present analysis apparatus and method has not only found that meaningful information can be obtained from a study of non-Bragg diffracted waves from both crystalline and non-crystalline samples, but has also found that quantitative information is achievable.

Further, not only has the inventor found this, but also has determined contrary to what might be thought, that such information is obtainable even when using a standard laboratory source (as opposed for example to when using beams of ultra-high intensity and ultra-low divergent radiation that are only found in the most expensive of synchrotrons).

The inventor has thus been able to provide an analysis technique that offers a practicable and high-resolution alternative to the prior art imaging methods.

The use of laboratory sources (as opposed to top-end e.g. 1 kilometre long synchrotron radiation sources) may be characterised by the generation of non-planar penetrating radiation, which is then collimated by the monochromator (with a resultant loss in beam intensity). Non-planar penetrating radiation in the present application may be considered to be radiation having an angular divergence of greater than 10 seconds of arc when incident at the monochromator.

In a preferred embodiment, the x-ray source is a characteristic line source such as an x-ray tube. In such sources, material is bombarded by electrons to generate the x-rays. The material may be e.g. copper, molybdenum, silver or tungsten.

In an especially preferred embodiment, the source is a rotating anode source. Such sources are similar to standard x-ray tube sources, but the material bombarded is rotated. Rotating anode sources are able to provide relatively high intensity beams so as to provide greater resolution and better signal to noise ratios in the intensity data.

For comparison, an x-ray tube typically generates x- rays having an energy range of from about 5 to 150 keV and having an intensity of about 10⁶ photons/sec, whilst a rotating anode source typically generates x-rays having an energy range of from about 5 to 60 keV and having an intensity of about 10⁸ photons/sec. Synchrotron radiation typically has an energy range of from about 1 to 100 keV and an intensity of about 10¹²⁻¹⁸ photons/sec.

Other laboratory sources of x-rays could also be used. These could include for example small-scale synchrotrons, e.g. which are able to fit into a room of a building, but which, because of their small beam lengths, may still require optical elements, such as a monochromator, to provide a beam of low angular divergence.

The analyser may take any suitable form, and for example may comprise a crystal oriented so that only x-rays of a set angle of incidence or range of angles and desired wavelength are diffracted towards the detector. It may comprise a single or double crystal that may be made of e.g. silicon or germanium. Silicon is preferred, and provides a stable and effective analyser.

The crystal analyser is the analyser of choice, but alternatives are possible. For example, the analyser could be in the form of an x-ray mirror.

The monochromator may also take any suitable form, and may take a form similar to that of the crystal analyser, e.g. a single or double crystal of silicon or germanium, or an x-ray mirror.

The monochromator and analyser pair provides the system with a set optical resolution, determined from e.g. the angular divergence of the beam leaving the monochromator and e.g. the angular acceptance of the analyser. The optical resolution will generally be the angular divergence of the beam after passing through the monochromator, or the angular acceptance of the analyzer, whichever is greater.

It is preferred that the monochromator and the analyser are of the same type and have equivalent angular divergence and angular acceptance values. However this is not essential for the operation of the invention.

The actual optical resolution of the apparatus can be taken from a rocking curve of the apparatus, i.e. an intensity profile of detected intensity versus analyser position for the apparatus without a sample in place. The optical resolution may be defined by the Full Width at Half Maximum of the rocking curve (FWHM).

The monochromator and analyser pair may be arranged so that the analyser is at its zero angle position when it is diffracting x-rays into the detector at the Bragg angle.

Preferably, x-rays pass through a slit prior to their incidence on the object, the slit size A (in a direction transverse to the direction of propagation of the beam and in the direction in which the refractive index is being measured) being such that:
A>λ/δθ,
where λ is the wavelength of the incident radiation, and δθ is the optical resolution of the apparatus used (e.g. the monochromator/analyser pair resolution, e.g. determined from the FWHM of the rocking curve).

A point to note here is that the optical resolution δθ is determined by the apparatus, rather than being a quality of the beam itself (which would be the case if a top-end synchrotron beam where used).

This use of a slit width within the above constraint ensures that the intensity profile detected is able to provide analytical functions for determining the object's refractive index, and so allows a quantitative analysis of the cross-sectional refractive index.

Typical slits widths may range from e.g. 50 to about 500 microns. A copper x-ray tube may for example utilise slit widths of between about 50 and about 300 microns, whilst a molybdenum source may utilise slit widths between about 50 and about 500 microns, and a silver source slit widths of between about 50 and about 300 microns. Preferably, the slit width is greater than 50 microns, and more preferably greater than 100 microns. It is preferably less than 500 microns, and may for example fall within the range of about 250 to about 300 microns.

The slit member that defines the slit is preferably made from tantalum, and the edges of the slit are preferably flat and parallel to the direction of propagation of the beam. This avoids the possibility that x-rays will penetrate the slit member about the edges of the slit, and cause undesired diffraction effects in the measured intensity profile.

As well as providing quantitative information, the intensity profile may merely be plotted e.g. as Log(intensity) against angular position of the analyser, and the resulting plot may be reviewed qualitatively e.g. against a similar plot for a reference sample.

The size of the slit in the second transverse direction may take any suitable value, and may be e.g. between about 0.1 mm and about 10 mm. The particular size may be dependent on the sample under analysis, and any desired spatial resolution in the second transverse direction (e.g. if an intensity profile were to be obtained in this direction also).

Preferably the crystal analyser is rotated in a plurality of incremental steps, each step being through an angle α:
α≦δθ/2
where δθ is again the optical resolution of the apparatus.

This constraint allows the complete determination of the complex scattering function. It takes into account the need to measure 2N points of a real function (i.e. intensity) in order to obtain N points of a complex function (which has both real and imaginary components).

A typical step may be e.g. 0.05 or 0.01 arc.secs, although other step sizes are equally possible.

The detector may take any suitable form, and, as said, need not provide any spatial resolution. Preferably, the detector comprises a PIN (P-intrinsic-N) diode detector. PIN diode detectors are able to provide a linear response over a large dynamic range. This can be an advantage in the present technique, as the scattered intensity profile to be recorded typically has a large variation in intensity, with useful information being contained in both high and low intensity areas: A typical profile of the logarithm of intensity against analyser angle comprises a large central peak with small but significant variations in intensity in the tails of the peak. As an alternative, a scintillation counter or the like may be used.

Preferably, a complex scattering amplitude of the irradiated portion of the object (in reciprocal space) is calculated from the detected intensities, and a complex scattering function of the irradiated portion is determined by taking an inverse Fourier Transform of the complex scattering amplitude.

The method preferably includes the steps of: normalising the detected intensities; calculating the modulus of the complex scattering amplitude from the normalised intensity; calculating phase information (e.g. a minimal phase) of the complex scattering amplitude from the modulus of the complex scattering amplitude; and determining the complex scattering amplitude from the modulus and the phase information.

The analysis of the detected intensity profiles may be carried out by any suitable means, and may be implemented in software running on any suitable computing apparatus, for example a personal computer, as would be well understood by a person skilled in the art. The computing apparatus could control the whole analysis operation and co-ordinate control of the analyser and detector, e.g. control the rotation of the analyser and the recordal of the detected intensities against angular position of the analyser.

The sample may be positioned relative to the slit, such that significant variation in the sample refractive index is expected only in the diffraction plane of the monochromator-analyser pair.

In one preferred embodiment, the object is translated relative to the beam, e.g. in a linear fashion, between obtaining profiles, so as to provide an analysis of the object over a number of beam widths. The results of the separate analyses of the various portions of the object may then be combined so as to provide a complex refractive index profile of the object over a large cross-sectional area. An object can therefore be mapped over a large area at a high resolution.

The present invention provides a refractive index profile for the sampled portion of the object in a direction transverse to the direction of beam propagation, the resulting profile also being the refractive index integrated over the distance that the beam propagates through the sample. In order to provide three-dimensional information, tomographic techniques may be employed.

It should be noted that the restriction of the slit width in accordance with the constraint discussed above is in itself an important feature of the present invention, and provides an intensity profile that is analytical and so allows for a quantitative analysis of the refractive index of-the sample.

Accordingly, viewed from a further aspect, the present invention provides a method of analysis of an object, the method including the steps of:

generating penetrating radiation;

diffracting the radiation from a monochromator to provide a beam of monochromatic penetrating radiation;

passing the beam of radiation through a slit, the slit size A (in a direction transverse to the direction of propagation of the beam) being calculated such that:
A≦λ/δθ
where λ is the wavelength of the incident radiation, and δθ is the optical resolution of the apparatus used in the method;

irradiating a portion of the object with the beam;

diffracting radiation that passes through the object onto a detector from an analyser;

rotating the analyser through a plurality of angular positions; and

measuring the intensity of the radiation incident on the detector as a function of analyser position.

The present invention may also be seen as providing an apparatus for the analysis of an object, the apparatus including:

a source of penetrating radiation;

a monochromator for diffracting the penetrating radiation to provide a beam of monochromatic penetrating radiation;

a slit member defining a slit through which the beam passes prior to the beam's incidence on the object, the slit size A (in a direction transverse to the direction of propagation of the beam) being calculated such that:
A≦λ/δθ
where λ is the wavelength of the incident radiation, and δθ is the optical resolution of the apparatus;

a detector for detecting radiation that passes through the object;

an analyser for diffracting radiation that passes through the object onto the detector;

means for rotating the analyser between a plurality of angular positions; and

means for recording the intensity of the radiation incident on the detector as a function of analyser position.

Viewed from a still further aspect, the present invention provides a method of analysis of an object, the method including the steps of:

irradiating a portion of the object with a beam of monochromatic x-rays;

detecting the intensity profile of an angular spectrum of the x-rays emerging from the irradiated portion; and

determining a complex scattering function for the irradiated portion of the object under analysis.

Viewed from another aspect, the present invention provides a method of analysis of an object, the method including the steps of:

irradiating a portion of the object with a beam of monochromatic x-ray radiation;

diffracting x-rays emerging from the sample into an x-ray detector using an analyser means; and

obtaining an angular spectrum of non-Bragg diffracted x-ray intensities as a function of angular position of the analyser means.

Viewed from a further aspect, the present invention provides a method of analysis of an object, the method including the step of collecting generic (non-Bragg diffracted) x-ray diffraction data from a portion of the object and analysing the data to obtain a complex refractive index of the sampled portion in a direction transverse to the beam propagation.

These further aspects may extend to apparatus for applying the methods, and may include any of the features of the preceding aspects of the present invention.

Embodiments of the present invention will now be described, by way of example only, with reference to the accompanying drawings. It is to be understood that the particularity of the drawings does not supersede the generality of the preceding description of the present invention.

In the drawings:

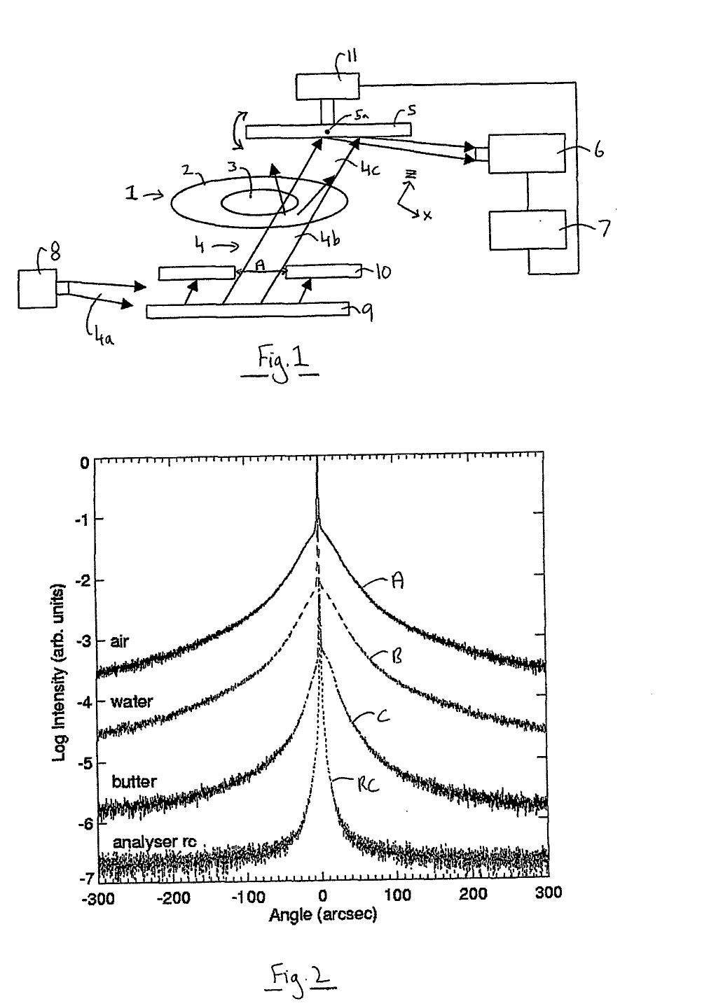

FIG. 1 is a schematic diagram of x-ray analysis apparatus in accordance with a first embodiment of the present invention;

FIG. 2 shows scattered intensity profiles for three analysed samples as a graph of Log(intensity) against detection angle;

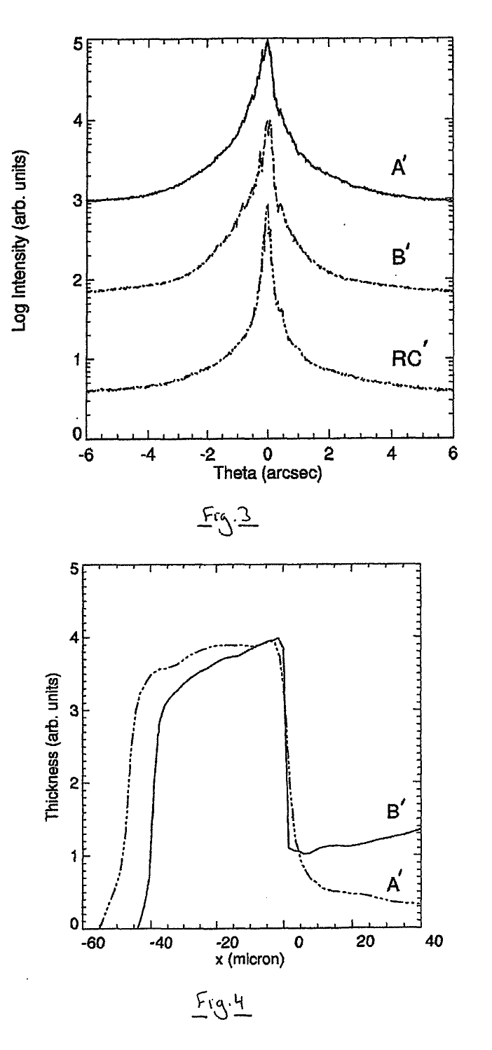

FIG. 3 shows the scattered intensity profile for a sample when placed at two different positions relative to a beam slit; and

FIG. 4 represents the profile of the real component of the complex refractive index for the two profiles of FIG. 3.

Referring to FIG. 1, an object 1 to be analysed, e.g. a blood vessel, will have regions of differing refractive index, e.g. an outer region 2 consisting of the blood vessel wall, and an inner region 3 consisting of the blood itself.

Overall, in order to analyse the internal structure of the object 1, a beam of x-ray radiation (generally labelled 4) is passed through the object 1, and the emerging radiation that is within the acceptance angle of a crystal analyser 5 is diffracted onto an x-ray detector 6. The detector 6 records an intensity profile of this radiation as a function of angular position of the crystal analyser 5, and suitable control means 7, such as a computer running suitable software, analyses the resulting profile to provide a complex refractive index profile for the object 1 across the width of the beam 4 in the x-axis direction (transverse to the direction of propagation of the beam 4).

In more detail, in the apparatus shown, an x-ray source 8, such as an Mo x-ray tube with K_{α}=0.709 nm, generates an x-ray beam 4a that is diffracted from a crystal monochromator 9 and passed through a slit member 10 so as to provide a narrow collimated beam of low divergence monochromatic x-rays 4b that is incident on the sample object 1.

The monochromator 6 is an Si crystal providing a (333) asymmetric reflection, and the crystal is cut such that (111) atomic planes are at 18.5° to the surface.

The slit member 10 is made of e.g. tantalum and the sides of the slit are flat and parallel to the direction of propagation of the beam so as to prevent x-rays from passing though the edges of the slit member 10 about the slit opening and causing undesirable diffraction effects.

The slit size, A, is selected to satisfy the relationship:
A≦λ/δθ
where λ is the wavelength of the incident radiation, and δθ is the optical resolution of the apparatus as determined by e.g. the angular divergence of the beam after the monochromator or the angular acceptance of the analyzer. In the present case, the optical resolution may be determined by the Full Width at Half Maximum (FWHM) of the rocking curve of the slit member 10, the rocking curve being the intensity profile obtained by the apparatus in the absence of a sample to be analysed.

The x-ray beam 4b is absorbed and scattered in its passage through the sample 1, and the emerging x-rays 4c that fall within the acceptance angle of the crystal analyser 5 are diffracted towards the detector 6.

The crystal analyser 5 may be of the same configuration as the monochromator 9, and may comprise an Si crystal providing a (333) asymmetric refraction, the crystal being cut such that (111) atomic planes are at 18.5° to the surface.

The crystal analyser 5 is arranged opposite to the entry point of the x-rays into the object 1, and is mounted to rotate in incremental steps about an axis 5a over a set range of angular positions so as to present itself at a plurality of different angles to the x-ray beam 4.

The means 11 for rotating the crystal analyser 5 may comprise e.g. a goniometer, and may be controlled by the control means 7, which also records the intensity of x-rays received at the detector 6 as a function of the angle of the analyser 5 from its zero position. The “zero” position of the analyser 5 relative to the beam 4 corresponds to the Bragg reflection angle of the analyser crystal, and in this position, the analyser is in this embodiment substantially parallel to the monochromator 9.

In use, the crystal analyser 5 is rotated between e.g. −30 arc.secs and +30 arc.secs of the Bragg reflection angle, in steps of e.g. 0.05 arc.secs. The steps should be less than half the optical resolution of the apparatus, e.g. as defined by the monochromator and analyser pair (This takes into account the need to acquire 2N real values in order to compute N complex values).

At each step, an intensity reading is recorded. This may be for a set period of time, for instance between about 1 to about 10 seconds. Alternatively, the intensity of the radiation at each step may be measured until a set number of photons is reached, e.g. 1000 photons. In such a case it may take e.g. from about 10 to 20 seconds to measure an intensity value at an extreme angular position, and e.g. from about 0.1 to 0.5 seconds to measure intensity at a point close to the peak of the profile. Each resulting intensity value may be modified to take account of the time taken to obtain it, e.g. by dividing the intensity value by the measurement time.

The detector 6 may be a PIN diode detector, which is able to provide a linear response over a large dynamic range. This is useful for the present technique, as the detector 6 needs to record both a large central peak of substantially unabsorbed and unrefracted radiation, as well as meaningful small perturbations in the tails of the profile caused by phase shifts in the x-rays as they pass through regions of the object of different refractive index. Alternative detectors may also be used, e.g. a scintillation counter.

Examples of intensity profiles that may be obtained through the use of the apparatus of FIG. 1 are shown in FIG. 2, which plots Log(Intensity) against crystal analyser angle.

The profiles A-C are of a polyethylene tube (approximately 6 mm in diameter and sealed at both ends) filled with air, water and butter respectively, so as to roughly simulate a blood vessel configuration: The air is used to imitate an empty blood vessel, whilst the water and butter are used to imitate a blood vessel filled with clear blood and organic fat respectively.

The profile RC provides an analyser rocking curve corresponding to no sample. The rocking curve may be used to calculate the optical resolution of the apparatus by determining the FWHM.

It should be noted that the scans are offset by about 1 decade for clarity, and that the sample may be immersed in water to reduce the change in refractive index that would otherwise occur at the interface of the sample object with air.

Inspection of such plots can provide qualitative information as to the object under analysis, e.g. one may be able to tell from such a plot if a blood vessel is abnormal.

The present invention can however also provide quantitative information as to the structure of the object from a suitable analysis of the intensity profile.

Overall, the concept is to obtain (in reciprocal space) the complex diffraction amplitude of the portion of the object analysed by the x-ray beam 4, and from this to obtain the complex refractive index profile of the analysed portion across the width of the beam. This complex refractive index will have information on both the absorptive and refractive features of the object under analysis, and so will provide information on the structure of the analysed portion of the object.

The analysis relies on the analytical properties of the complex diffraction amplitude, which is provided by the use of a slit width A within the above-noted constraints.

The refractive index profile obtained will be that along the x-axis of the portion of the object that is analysed (integrated over the length of the object through which the beam passes), and assumes that the object is homogeneous or has a slowly varying refractive index in the y-axis direction (In FIG. 1, this direction is out of the plane of the paper).

As a specific example, a profile may be analysed by firstly normalising the measured intensity, I(θ), by the square modulus of the complex scattering vector:
Q²=q²+μ²
where q=θ/λ and μ is the linear attenuation coefficient of the material.

The normalised intensity is:
Ĩ(Q)=I(Q)×Q².

Next, the modulus |R(Q)| of the complex diffraction amplitude, R(Q), is calculated as the square root of the normalized intensity:
R(Q)=\sqrt{Ĩ(Q)}.

The minimal phase is then calculated from the square root of the measured intensity using a logarithmic Hilbert transform. This can be implemented using the relation between Hilbert and Fourier transforms (see e.g. R. N. Bracewell, The Fourier transform and its applications (McGraw-Hill, New York, 1986):

$${φ}^{min} ( Q ) = - \frac{1}{π} P {\int }_{- ∞}^{∞} \frac{ln \vert R ( q ) \vert}{{q}^{′} - q} ⅆ {q}^{′} ,$$

where P is the Cauchy principle value of the integral.

The solution for the Complex Diffraction Amplitude can then be synthesised as:
R(Q)=|R(Q)|exp{iφ^{min}(Q)}.

Next, the inverse Fourier transform of R(Q) is taken:
\tilde{χ}(x)=ℑ⁻¹{R(Q)}.

The complex refractive index profile of the sample across the width of the beam can then be obtained by taking the integral:

$$χ ( x ) = {\int }_{0}^{A} \tilde{χ} ( x ) ⅆ x .$$

An unambiguous solution to the complex refraction index profile may be obtained either by using intensity profiles collected for two different x-ray energies or by using a single intensity profile compared to previously obtained benchmark profiles for similar samples. The results obtained for the two profiles can then be compared so as to identify physically real roots from artefacts of the computation.

In one experiment, the apparatus of FIG. 1 was used to analyse a sample of nylon (C₆H₁₃NO₂, density −0.4336 g/cm³) of 80 micron diameter.

The sample was arranged to occlude the slit in the slit member 10 such that the whole sample is “seen” through the slit plus a bit of air.

The apparatus had an optical resolution of δθ=0.12 arc.sec.=5.87×10⁻⁷ rad, and the slit aperture was selected to be 110 microns, which satisfies the condition that the slit aperture must be smaller than:
A=λ/δθ=7.09×10⁻¹¹/5.87×10⁻⁷≅120 micron.

The angular step in the diffraction pattern, i.e. the angular step of the crystal analyser 5 was chosen to be 0.05 arc.sec.—at least two times smaller than the optical resolution.

The intensity profile (generic optical diffraction pattern), I(θ), was determined from the sample by the angular scanning of the analyser from −10 arc.sec. to +10 arc.sec (giving 401 experimental points). This gave a total angular scan aperture:
θₐₚₑᵣₜᵤᵣₑ=20 arc.sec.=9.7×10⁻⁵ rad.

This corresponds to a resolution for the reconstructed profile of the refractive index of the sample across the beam width of:
Δx=λ/θ=7×10⁻¹¹/9.7×10^{-5=0.72} micron.

Further examples of intensity profiles obtained using the apparatus of FIG. 1 are shown in FIG. 3. They are for a model blood vessel comprised of a 1 mm diameter grass straw cylinder located partially in the x-ray beam 4 (only one edge of the straw was within the beam, the other edge was blocked by the slit member 10).

The sample was immersed in water, so that the total thickness of the sample cell was about 1.5 mm, with 2×50 micron Kapton™ windows to the sample cell.

The x-ray radiation was Mo K_{α1}=17.5 keV.

The monochromator/analyser pair used a single silicon dislocation-free crystal with an asymmetric cut that had an asymmetry factor b=0.038. Bragg reflection was Si 333, and Darwin's width was 0.12 arc.sec.

The slit size was 0.1 mm (x-axis, A dimension)×5 mm (y-axis).

The two profiles A′ and B′ shown in FIG. 3 are for two positions of the sample relative to the 100 μm wide slit. Profile RC′ is a rocking curve for the apparatus corresponding to no sample, i.e. an open slit.

In scan A′, the sample occludes the slit by 58±2 μm, and in scan B′, the sample occludes the slit by 40±2 μm.

FIG. 4 shows the reconstructed profile of the real component of the complex refractive index of the sample (proportional to the thickness/density profile in the direction of the incident x-rays).

The drop on the right side of the profile corresponds to the slit edge, and the drop on the left-side corresponds to the edge of the sample. The left-side drop has shifted by about 15 micron between the two profiles, corresponding to the movement of the sample between measurements of the profiles.

The spatial resolution of the reconstruction was 1.5 μm.

The basis for the present approach to x-ray analysis is as follows. In the case of a non-crystalline sample, the complex scattering function of the sample may be expressed as:

$$t ( x ) = exp \{ \frac{2 π}{λ} i \int n ( x , y , {z}^{′} ) ⅆ {z}^{′} \}$$

where n is the map of the complex refractive indices, n(x,y,z)=1−∂(x,y,z)-iβ(x,y,z), and z is the direction of the incident wave propagation, for an ideally monochromatic source of wavelength λ.

The experimentally measured scattered intensity (i.e. that obtained at detector 6) is the square of the modulus of the complex scattering amplitude, I=|T(Q)|², where T(Q) is given as the Fourier transform of the complex scattering function t(x):

$$T ( Q ) = \vert T ( Q ) \vert exp ( i ϕ ( Q ) ) = {\int }_{all space} t ( x ) exp ( 2 π i Q x ) ⅆ x$$

where T(Q)=u(qᵣ,qᵢ)+iv(qᵣ,qᵢ) and qᵣ, qᵢ are the real and imaginary parts respectively of the complex scattering vector Q=qᵣ+iq.

The inverse problem of determining the complex scattering function t(x) from the experimentally observed scattered intensity profile I(Q) depends on the theoretical approach to the relation between the modulation function and the observed intensity function.

The phase φ(Q) of the experimentally observed x-ray scattering profile may be retrieved via a logarithmic dispersion relation, an approach that is valid under the kinematical theory of x-ray scattering:

$$ϕ ( Q ) = - \frac{1}{π} P {\int }_{- ∞}^{∞} \frac{ln \vert T ( {Q}^{′} ) \vert}{{Q}^{′} - Q} {dQ}^{′} + 2 {\sum }_{m} arg ( Q - {Q}^{m} ) = {ϕ}^{min} ( Q ) + {\sum }_{m} {ϕ}^{m} ( Q )$$

where Q^{m}(m=0,1,2, . . . M-1) are the zeros of |T(Q)| in the upper half of the complex plane, and P is the Cauchy principal value of the integral. The zeros of the scattered amplitude, Q^{m}, are of unknown number, M, and may in principle be infinite in number. However, the analyticity of the CDA allows its unique representation as a complex polynomial function:

$$T ( Q ) = {\prod }_{k = 0}^{K - 1} ( Q - {Q}^{k} )$$

in which the number of zeros is limited to the discrete number of points K in the experimentally collected data set.

Once the x-ray phase, φ(Q), is determined, e.g. the minimal phase change term, an inverse Fourier transform of the calculated complex scattering amplitude T(Q) can be used to find the complex scattering function t(x) and provide information on the thickness/composition profile.

Overall, the present invention can provide a method and apparatus for the x-ray analysis of a sample, which is able to provide high resolution and good contrast without great expense, and can provide information as to both absorptive and refractive features of the sample in a single experiment. The invention utilises an angular spectrum of non-Bragg diffracted x-rays obtained from standard laboratory x-ray sources, and is not limited for example to expensive top-end synchrotron sources or the like. The invention can ensure analyticity of the resulting profiles through the slit constraints determined with respect to the optical resolution imposed by the analysing apparatus.

The invention may be used in situations requiring non-invasive analysis techniques, and may be used in the medical and non-medical fields, in relation to organic and non-organic materials, inanimate or living objects, and crystalline and amorphous substances.

In the medical field, the invention may be used e.g. in the cardiovascular, oncological and urological fields in measuring occlusions.

In non-medical fields, the present invention may be used in e.g. the characterisation of light metal alloys, e.g. as used in the aerospace industry. The invention may be used to measure e.g. stresses and strains in crystalline material (the invention analysing the movement of groups of atoms, as opposed to detecting individual atoms themselves).

The invention may be extended to provide further information about a sample e.g. in the y-axis and z-axis. For example, the apparatus could be arranged to further scan in the y-direction, and the object or apparatus could be rotated to provide other beam paths through the object, and to correlate the information obtained in a manner as in tomography.

It is to be understood that various modifications and/or alterations may be made to the above without departing from the spirit of the invention as outlined herein.

For example, although discussed in terms of x-rays generated by an x-ray tube, any other suitable x-ray source could be used, including e.g. synchrotron radiation. Also, the monochromator and analyser could take any other suitable form, and could e.g. be comprised of double crystals and could be made of germanium. Alternative diffraction analysers could also be used such as X-ray mirrors. The detector could also take any other suitable form.

1-41. (canceled)

42. A method of analysis of an object, comprising:
generating non-planar penetrating radiation;
diffracting the radiation from a monochromator to provide a beam of monochromatic penetrating radiation;
irradiating a portion of the object with the beam of monochromatic penetrating radiation;
diffracting, from an analyzer onto a detector, penetrating radiation that passes through the object onto the analyzer;
rotating the analyzer through a plurality of angular positions; and
measuring a plurality of intensities of the radiation incident on the detector as a function of analyzer position.

43. The method of claim 42, comprising determining, from the measured intensities, a complex scattering function of the portion of the object.

44. The method of claim 42, comprising passing the beam of radiation in a direction of propagation through a slit prior to incidence of the beam on the portion of the object, wherein the slit has a size A in a direction transverse to the direction of propagation of the beam and calculated according to the formula:
A≦λ/δθ
wherein λ is the wavelength of incident radiation and δθ is optical resolution provided by the monochromator and the analyzer.

45. The method of claim 42 wherein the analyzer is rotated in incremental steps α, wherein α≦δ↓/2 and δθ is optical resolution provided by the monochromator and the analyzer.

46. The method of claim 42 wherein the detector comprises a PIN diode detector.

47. The method of claim 42 wherein the step of generating comprises producing radiation from a characteristic line source.

48. The method of claim 47 wherein the characteristic line source is a rotating anode source.

49. The method of claim 42, comprising:
calculating a complex scattering amplitude of the irradiated portion of the object from the measured intensities; and
determining from said complex scattering amplitude an inverse Fourier Transform to obtain a complex scattering function.

50. The method of claim 49, comprising:
normalizing the measured intensities;
calculating a modulus of the complex scattering amplitude from the normalized intensities;
calculating, from said modulus, phase information for the complex scattering amplitude; and
determining, from said modulus and phase information, the complex scattering amplitude.

51. The method of claim 42, comprising:
determining, from the measured intensities, a complex scattering function of the portion of the object; and
determining, from the complex scattering function, a complex refractive index profile of the irradiated portion of the object.

52. An apparatus for analyzing an object, comprising:
a source of non-planar penetrating radiation;
a monochromator for diffracting the non-planar penetrating radiation to provide a beam of monochromatic penetrating radiation, said beam having a direction of propagation;
a detector for detecting the monochromatic penetrating radiation that passes through an object;
an analyzer for diffracting the monochromatic penetrating radiation that passes through the object onto the detector;
means for rotating the analyzer between a plurality of angular positions; and
means for recording one or a plurality of intensities of radiation incident on the detector as a function of analyzer position.

53. The apparatus of claim 52 comprising means for determining, from the recorded intensities, a complex scattering function of the object.

54. The apparatus of claim 52 comprising a slit through which the beam of monochromatic penetrating radiation passes prior to incidence of the beam on the object, wherein the slit has a size A in a direction transverse to the direction of propagation of the beam and calculated according to the formula:
A≦/δθ
wherein λ is the wavelength of incident radiation and δθ is optical resolution provided by the apparatus.

55. The apparatus of claim 52 wherein the analyzer is rotated in incremental steps α, wherein α≦δθ/2 and δθ is optical resolution provided by the apparatus.

56. The apparatus of claim 52 wherein the detector comprises a PIN diode detector.

57. The apparatus of claim 52 wherein the source of non-planar penetrating radiation comprises a characteristic line source.

58. The apparatus of claim 52 wherein the source of non-planar penetrating radiation comprises a rotating anode source.

59. The apparatus of claim 52 comprising means for determining, from the measured intensities, a complex scattering function of the object, wherein said means for determining a complex scattering function comprises (i) means for calculating, from the recorded intensities, a complex scattering amplitude of an irradiated portion of the object; and (ii) means for determining from said complex scattering amplitude an inverse Fourier Transform to obtain a complex scattering function.

60. The apparatus of claim 59, comprising:
means for normalizing the measured intensities;
means for calculating a modulus of the complex scattering amplitude form the normalized intensities;
means for calculating, from said modulus, phase information for the complex scattering amplitude; and
means for determining, from said modulus and phase information, the complex scattering amplitude.

61. A method of analysis of an object, comprising:
generating penetrating radiation;
diffracting the radiation from a monochromator to provide a beam of monochromatic penetrating radiation;
passing the beam of radiation in a direction of propagation through a slit, wherein the slit has a size A in a direction transverse to the direction of propagation of the beam and calculated according to the formula:
A≦λ/δθ
wherein λ is the wavelength of incident radiation and δθ is optical resolution provided by the monochromator and an analyzer;
irradiating a portion of the object with the beam;
diffracting, from the analyzer onto a detector, radiation that passes through the object onto the analyzer;
rotating the analyzer through a plurality of angular positions; and
measuring a plurality of intensities of the radiation incident on the detector as a function of analyzer position.

62. The method of claim 61 comprising determining, from the measured intensities, a complex scattering function of the portion of the object.

63. The method of claim 61 wherein the penetrating radiation is non-planar penetrating radiation.

64. The method of claim 61 wherein the analyzer is rotated in incremental steps α, wherein α≦δθ/2 and δθ is optical resolution provided by the monochromator and the analyzer.

65. The method of claim 61 wherein the detector comprises a PIN diode detector.

66. The method of claim 61 wherein the step of generating comprises producing radiation from a characteristic line source.

67. The method of claim 66 wherein the characteristic line source is a rotating anode source.

68. The method of claim 61, comprising:
calculating a complex scattering amplitude of the irradiated portion of the object from the measured intensities; and
determining from said complex scattering amplitude an inverse Fourier Transform to obtain a complex scattering function.

69. The method of claim 68, comprising:
normalizing the measured intensities;
calculating a modulus of the complex scattering amplitude from the normalized intensities;
calculating, from said modulus, phase information for the complex scattering amplitude; and
determining, from said modulus and phase information, the complex scattering amplitude.

70. The method of claim 61, comprising:
determining, from the measured intensities, a complex scattering function of the portion of the object; and
determining, from the complex scattering function, a complex refractive index profile of the irradiated portion of the object.

71. An apparatus for analyzing an object, comprising:
a source of penetrating radiation;
a monchromator for diffracting the penetrating radiation to provide a beam of monochromatic penetrating radiation, said beam having a direction of propagation;
a slit member defining a slit through which the beam passes prior to incidence of the beam on the object, wherein the slit has a size A in a direction transverse to the direction of propagation of the beam and calculated according to the formula:
A≦λ/δθ
wherein λ is the wavelength of incident radiation and δθ is optical resolution of the apparatus;
a detector for detecting radiation that passes through the object;
an analyzer for diffracting the radiation that passes through the object onto the detector;
means for rotating the analyzer between a plurality of angular positions; and
means for recording one or a plurality of intensities of radiation incident on the detector as a function of analyzer position.

72. The apparatus of claim 71, comprising means for determining, from the recorded intensities, a complex scattering function of a portion of the object.

73. The apparatus of claim 71 wherein the analyzer is rotated in incremental steps α, wherein α≦δθ/2 and δθ is optical resolution provided by the apparatus.

74. The apparatus of claim 71 wherein the detector comprises a PIN diode detector.

75. The apparatus of claim 71 wherein the source of radiation is a characteristic line source.

76. The apparatus of claim 71 wherein the source of radiation is a rotating anode source.

77. The apparatus of claim 71 comprising means for determining, from the measured intensities, a complex scattering function of the object, wherein said means for determining a complex scattering function comprises (i) means for calculating, from the recorded intensities, a complex scattering amplitude of an irradiated portion of the object; and (ii) means for determining from said complex scattering amplitude an inverse Fourier Transform to obtain a complex scattering function.

78. The apparatus of claim 77, comprising:
means for normalizing the measured intensities;
means for calculating a modulus of the complex scattering amplitude form the normalized intensities;
means for calculating, from said modulus, phase information for the complex scattering amplitude; and
means for determining, from said modulus and phase information, the complex scattering amplitude.

79. A method of analyzing an object, comprising:
irradiating a portion of the object with a beam of monochromatic x-rays;
detecting an intensity profile of an angular spectrum of x-rays emerging from the irradiated portion; and
determining a complex scattering function for the irradiated portion of the object.

80. A method of analyzing an object, comprising:
irradiating a portion of the object with a beam of monochromatic x-ray radiation;
diffracting, with an analyzer means, x-rays emerging from the portion of the object into an x-ray detector; and
obtaining an angular spectrum of non-Bragg diffracted x-ray intensities as a function of angular position of the analyzer means.

81. A method of analyzing an object, comprising:
collecting generic x-ray diffraction data from a portion of the object that is irradiated with a beam having a direction of propagation; and
analyzing said data to obtain a complex refractive index of the portion in a direction that is transverse to the direction of propagation of the beam.
